(19) United States
(12) Patent Application Publication
(10) Pub. No.: US 2026/0290167 A1
(43) Pub. Date: Sep. 24, 2026

(54) PARKING LOT MANAGEMENT DEVICE, PARKING LOT MANAGEMENT METHOD, AND STORAGE MEDIUM

(71) Applicant: HONDA MOTOR CO., LTD., Tokyo (JP)

(72) Inventors: Yuki HARA, Tokyo (JP); Hideo NAKAHAMA, Tokyo (JP); Kazuki YAMANO, Tokyo (JP)

(73) Assignee: HONDA MOTOR CO., LTD., Tokyo (JP)

(21) Appl. No.: 19/570,185

(22) Filed: Mar. 18, 2026

(30) Foreign Application Priority Data
Mar. 19, 2025 (JP) 2025-044459

(51) Int. Cl. G08G 1/14

(52) U.S. Cl. CPC G08G 1/143; G08G 1/144

(57) ABSTRACT

A parking lot management device guides a user, who wishes to use a parking lot having a plurality of parking frames available for parking a vehicle, to a parking frame identified from among the plurality of parking frames, and the parking lot management device includes a processor configured to: acquire destination information indicating a destination of the user; refer to a storage that stores parking frame information indicating an evaluation value of each parking frame for each destination, and identify a guidance parking frame, which is a parking frame whose evaluation value corresponding to the destination of the user satisfies a predetermined condition, from among the plurality of parking frames based on the acquired destination information; and transmit guidance parking frame information indicating the identified guidance parking frame to a user terminal used by the user.

### CROSS-REFERENCE TO RELATED APPLICATIONS

This application is based on and claims priority under 35 USC 119 from Japanese Patent Application No. 2025-044459 filed on Mar. 19, 2025, the contents of which are incorporated herein by reference.

### TECHNICAL FIELD

The present disclosure relates to a parking lot management device, a parking lot management method, and a storage medium.

### BACKGROUND

In recent years, improvements in traffic safety have been required to enable inclusion, safety, toughness, and sustainability of urban and human residents. From a viewpoint of improving the traffic safety, for example, developments of a driving assistance technique and an autonomous driving technique for vehicles have been advanced.

As an example of the driving assistance technique, Japanese Patent Application Laid-Open Publication No. 2016-197314 discloses a driving assistance device that recognizes a landmark included in an image received from a vehicle and delivers, to the vehicle, driving assistance information that corresponds to a position of the vehicle determined based on a predetermined position where the landmark is disposed.

Japanese Patent Application Laid-Open Publication No. 2003-166836 discloses a technique in which, when a user instructs display of an underground building, a currently displayed map screen is reduced in a height direction of a screen and displayed at an upper side of the screen, and a three-dimensional image of the instructed underground building is displayed at a lower side of the screen.

However, in the related art, there was room for improvement in terms of improving convenience for a user who wishes to use a parking lot having a plurality of parking frames available for parking a vehicle.

The present disclosure provides a parking lot management device, a parking lot management method, and a storage medium that can improve convenience for a user who wishes to use a parking lot having a plurality of parking frames available for parking a vehicle.

### SUMMARY

A first aspect of the present disclosure relates to a parking lot management device. The parking lot management device guides a user, who wishes to use a parking lot having a plurality of parking frames available for parking a vehicle, to a parking frame identified from among the plurality of parking frames, and the parking lot management device includes a processor configured to: acquire destination information indicating a destination of the user; refer to a storage that stores parking frame information indicating an evaluation value of each parking frame for each destination, and identify a guidance parking frame, which is a parking frame whose evaluation value corresponding to the destination of the user satisfies a predetermined condition, from among the plurality of parking frames based on the acquired destination information; and transmit guidance parking frame information indicating the identified guidance parking frame to a user terminal used by the user.

A second aspect of the present disclosure relates to a parking lot management method performed by a computer. The computer guides a user, who wishes to use a parking lot having a plurality of parking frames available for parking a vehicle, to a parking frame identified from among the plurality of parking frames, and the parking lot management method includes: acquiring destination information indicating a destination of the user; referring to a storage that stores parking frame information indicating an evaluation value of each parking frame for each destination, and identifying a guidance parking frame, which is a parking frame whose evaluation value corresponding to the destination of the user satisfies a predetermined condition, from among the plurality of parking frames based on the acquired destination information; and transmitting guidance parking frame information indicating the identified guidance parking frame to a user terminal used by the user.

A third aspect of the present disclosure relates to a non-transitory computer-readable storage medium storing a program for causing a computer to execute a process. The computer guides a user, who wishes to use a parking lot having a plurality of parking frames available for parking a vehicle, to a parking frame identified from among the plurality of parking frames, and the process includes: acquiring destination information indicating a destination of the user; referring to a storage that stores parking frame information indicating an evaluation value of each parking frame for each destination, and identifying a guidance parking frame, which is a parking frame whose evaluation value corresponding to the destination of the user satisfies a predetermined condition, from among the plurality of parking frames based on the acquired destination information; and transmitting guidance parking frame information indicating the identified guidance parking frame to a user terminal used by the user.

According to the present disclosure, a parking lot management device, a parking lot management method, and a storage medium can be provided that can improve convenience for a user who wishes to use a parking lot having a plurality of parking frames available for parking a vehicle. This hence contributes to development of a sustainable transportation system.

### BRIEF DESCRIPTION OF DRAWINGS

Exemplary embodiments of the present disclosure will be described in detail based on the following figures, wherein:

FIG. 1 is a diagram illustrating an example of a parking assistance system 1 including a parking lot management device 100 according to the present embodiment;

FIG. 2 is a block diagram illustrating an example of a hardware configuration of the parking lot management device 100;

FIG. 3 is a diagram illustrating an example of parking frame information 102a;

FIG. 4 is a block diagram illustrating an example of a hardware configuration of a user terminal TU;

FIG. 5 is a block diagram illustrating an example of functional configurations of the parking lot management device 100 and the user terminal TU;

FIG. 6 is a diagram illustrating a situation in a parking lot PA immediately after a vehicle V enters the parking lot PA;

FIG. 7 is a diagram illustrating a situation in which the vehicle V is parked in a parking frame Fp in the parking lot PA;

FIG. 8 is a diagram illustrating a display example of a questionnaire screen Ga displayed on the user terminal TU;

FIG. 9 is a diagram illustrating an example of updating of the parking frame information 102a;

FIG. 10 is a flowchart illustrating an example of processing performed by the parking lot management device 100;

FIG. 11 is a block diagram illustrating an example of functional configurations of the parking lot management device 100 and the vehicle V according to a first modification; and

FIG. 12 is a block diagram illustrating an example of functional configurations of the parking lot management device 100, the vehicle V, and a smartphone TUb according to a second modification.

### DESCRIPTION OF EMBODIMENTS

Hereinafter, an embodiment of a parking lot management device, a parking lot management method, and a program of the present disclosure will be described in detail with reference to the drawings.

The drawings are viewed in directions of reference signs. Note that the following embodiment does not limit the present disclosure, and not all of elements described in the following embodiment are necessary for the present disclosure. In the following description, the same or similar elements are denoted by the same or similar reference numerals, and a description thereof may be omitted or simplified.

### 1. Parking Assistance System

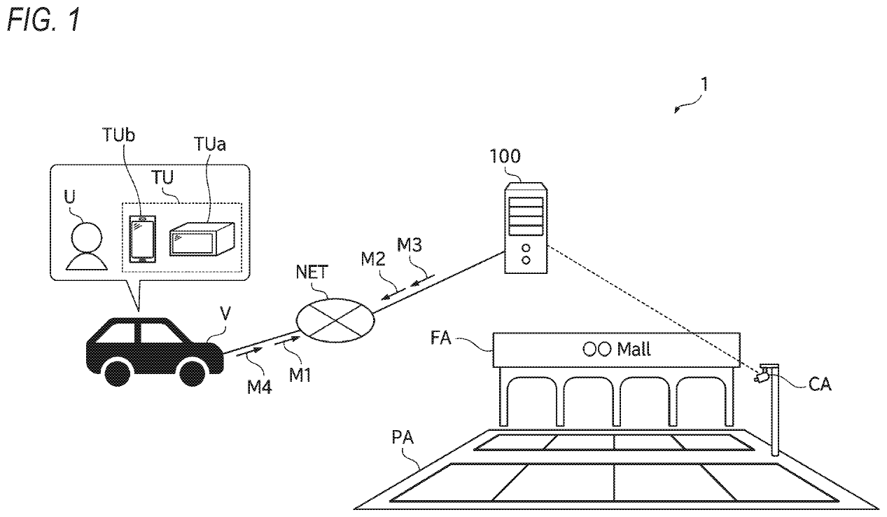

A parking assistance system 1 illustrated in FIG. 1 is a system that includes a parking lot management device 100 implemented by a server (that is, a computer) installed in a facility FA having a plurality of stores such as a shopping mall or a data center, and a user terminal TU used by a user U of a vehicle V, and assists in parking of the vehicle V in a parking lot PA of the facility FA. Here, the parking lot PA is a relatively large parking lot having a large number of parking frames (in other words, parking spaces) Fp available for parking the vehicle V, which is a four-wheeled automobile.

Specifically, in the parking assistance system 1, the parking lot management device 100 and the user terminal TU are configured to communicate with each other via a communication network NET. The communication network NET is, for example, a mobile communication network such as the so-called “4G” or “5G”, or a wireless communication network such as the Wi-Fi (registered trademark), Bluetooth (registered trademark), Bluetooth Low Energy (BLE) (registered trademark), or Low Power Wide Area (LPWA).

The user terminal TU is, for example, a navigation device TUa provided in the vehicle V, or a smartphone TUb used by the user U. Here, the navigation device TUa is an example of a device installed in the vehicle V used by the user U. The smartphone TUb is an example of a portable terminal of the user U that can communicate with the vehicle V.

The information transmitted and received between the parking lot management device 100 and the user terminal TU includes, for example, destination information M1, guidance parking frame information M2, questionnaire information M3, and answer result information M4. These pieces of information M1 to M4 will be described in detail below.

The parking lot management device 100 communicates with the user terminal TU of the user U who wishes to use the parking lot PA, and guides the user U who wishes to use the parking lot PA to a parking frame Fp that corresponds to a destination set by the user U (for example, a store in the facility FA). In this way, it is possible to park the vehicle V in an appropriate parking frame Fp taking the destination of the user U into consideration, thereby improving convenience for the user U. In other words, the parking lot management device 100 can also be said to be a parking assistance device that assists in parking in the appropriate parking frame Fp taking the destination of the user U into consideration.

The parking lot management device 100 is configured to communicate with, for example, a camera CA installed in the parking lot PA in addition to the user terminal TU. The parking lot management device 100 is configured to grasp entry of the vehicle V into the parking lot PA, the parking frame Fp in which the vehicle V is parked, and a current situation of the parking lot PA such as which of the parking frames Fp in the parking lot PA is available, through images from this camera CA.

### 2. Parking Lot Management Device

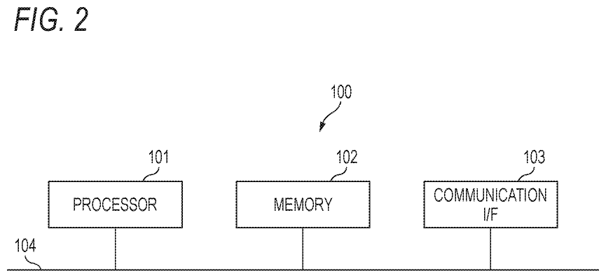

As illustrated in FIG. 2, the parking lot management device 100 includes, for example, a processor 101, a memory 102, and a communication I/F (interface) 103. These components of the parking lot management device 100 are connected to each other by a bus 104.

The processor 101 is responsible for overall control of the parking lot management device 100. The processor 101 is implemented by, for example, a central processing unit (CPU), a micro controller unit (MCU), or a micro processor unit (MPU). Note that the processor 101 may include a plurality of cores.

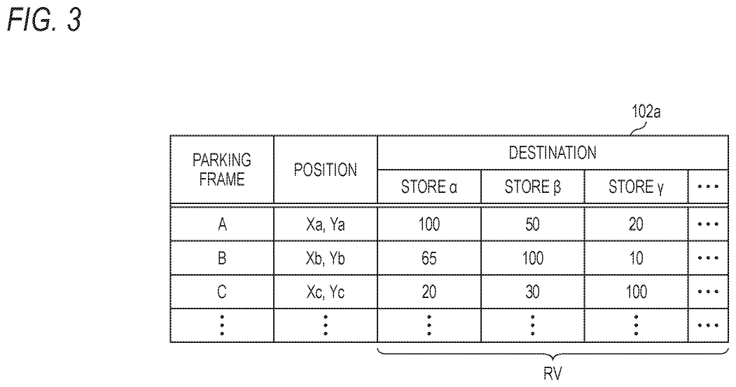

The memory 102 is, for example, a storage unit including non-transitory storage media such as a read only memory (ROM), a random access memory (RAM), and a flash ROM. For example, the flash ROM and the ROM store various programs, and the RAM is used as a work area of the processor 101. The programs stored in the memory 102 are loaded into the processor 101 to cause the processor 101 to execute coded processing. The programs stored in the memory 102 may include a program of the present disclosure. The memory 102 may also store parking frame information 102a, which will be described below, with reference to FIG. 3, for example.

The communication I/F (interface) 103 is connected to the communication network NET and is connected to an external device (for example, the user terminal TU) via the communication network NET. The communication I/F 103 serves as an interface between the communication network NET and the inside of the parking lot management device 100, and controls input and output of data to and from the external device.

### 3. Parking Frame Information

The parking frame information 102a illustrated in FIG. 3 is information that indicates a position of each parking frame Fp in the parking lot PA, an evaluation value RV of each parking frame Fp for each destination De, and the like. Here, the destination De is, for example, the store in the facility FA. In other words, the parking frame information 102a can also be said to be information that indicates the evaluation value RV of each parking frame Fp for each store in the facility FA.

For example, the parking frame information 102a illustrated in FIG. 3 indicates that a position of a parking frame A in the parking lot PA is (Xa, Ya), the evaluation value RV of the parking frame A corresponding to a store α is 100, the evaluation value RV corresponding to a store β is 50, and the evaluation value RV corresponding to a store γ is 20. The parking frame information 102a illustrated in FIG. 3 also indicates that a position of a parking frame B in the parking lot PA is (Xb, Yb), the evaluation value RV of the parking frame B corresponding to the store α is 65, the evaluation value RV corresponding to the store β is 10, and the evaluation value RV corresponding to the store γ is 10.

Note that the evaluation value RV in the parking frame information 102a is set by, for example, statistically processing evaluation from the user obtained through a questionnaire, which will be described below. In other words, the evaluation value RV indicates a level evaluated by the user who uses the parking lot PA. The evaluation value RV may be set or updated manually by an administrator who manages the parking lot management device 100, but is preferably set or updated automatically by the parking lot management device 100 in order to reduce trouble to the administrator.

### 4. User Terminal

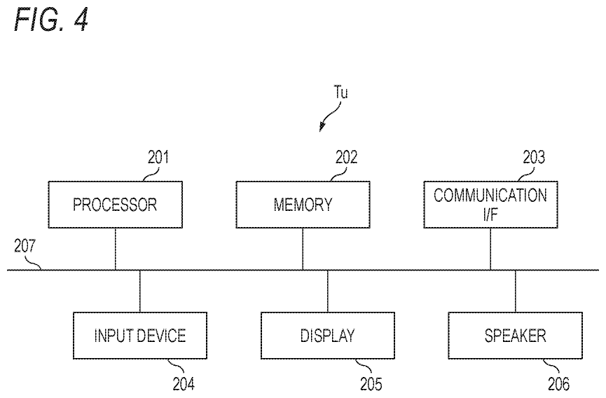

As illustrated in FIG. 4, the user terminal TU includes, for example, a processor 201, a memory 202, a communication I/F 203, an input device 204, a display 205, and a speaker 206. These components of the user terminal TU are connected to each other by a bus 207.

The Processor 201 is responsible for overall control of the user terminal TU. the processor 201 is implemented by, for example, a CPU, an MCU, or an MPU. Note that the processor 201 may include a plurality of cores.

The memory 202 is a storage unit including non-transitory storage media such as a ROM, a RAM, and a flash ROM. For example, the flash ROM and the ROM store various programs, and the RAM is used as a work area of the processor 201. The programs stored in the memory 202 are loaded into the processor 201 to cause the processor 201 to execute coded processing.

The communication I/F 203 is connected to the communication network NET and is connected to an external device (for example, the parking lot management device 100) via the communication network NET. The communication I/F 203 serves as an interface between the communication network NET and the inside of the user terminal TU, and controls input and output of data to and from the external device.

The input device 204 has keys for inputting letters, numbers, various instructions, and the like, and is used to input data. The input device 204 may be a touch panel type input pad or a numeric keypad, or may be a keyboard or a mouse. The input device 204 may also include an audio input device such as a microphone that receives sound and converts the sound into an electrical signal.

The display 205 is a display device capable of displaying documents, images, and the like, such as a cursor, an icon, a tool box, and a link button. The display 205 is, for example, a liquid crystal display or an organic electro luminescence (EL) display. The speaker 206 converts an electrical signal into sound and outputs the sound.

### 5. Example of Functional Configuration of Parking Lot Management Device and User Terminal

### Parking Lot Management Device

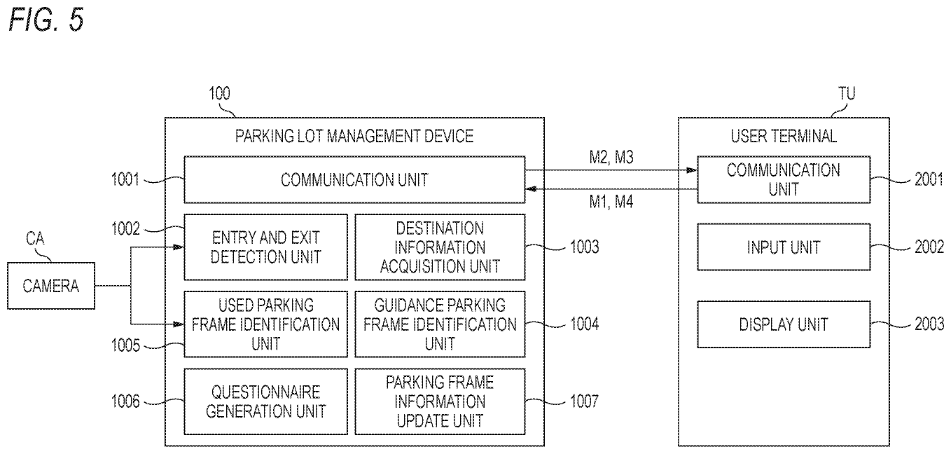

As illustrated in FIG. 5, the parking lot management device 100 includes a communication unit 1001, an entry and exit detection unit 1002, a destination information acquisition unit 1003, a guidance parking frame identification unit 1004, a used parking frame identification unit 1005, a questionnaire generation unit 1006, and a parking frame information update unit 1007. The communication unit 1001 is implemented by, for example, the communication I/F 103. The entry and exit detection unit 1002, the destination information acquisition unit 1003, the guidance parking frame identification unit 1004, the used parking frame identification unit 1005, the questionnaire generation unit 1006, and the parking frame information update unit 1007 are implemented by the processor 101 executing the programs stored in the memory 102 or by the communication I/F 103.

The communication unit 1001 communicates with the user terminal TU via the communication network NET. For example, the communication unit 1001 receives destination information M1 and answer result information M4, which will be described below, from the user terminal TU. The communication unit 1001 also transmits information such as guidance parking frame information M2 and questionnaire information M3, which will be described below, to the user terminal TU.

The entry and exit detection unit 1002 detects that the vehicle V of the user U has entered the parking lot PA based on images from the camera CA installed in the parking lot PA. Furthermore, the entry and exit detection unit 1002 may detect that the vehicle V of the user U has exited the parking lot PA.

The destination information acquisition unit 1003 acquires the destination information M1 indicating the destination De of the user U from the user terminal TU of the user U of vehicle V that has entered the parking lot PA (in other words, the user U who wishes to use the parking lot PA). The destination information acquisition unit 1003 acquires the destination information M1 via the communication unit 1001.

The guidance parking frame identification unit 1004 refers to the parking frame information 102a stored in the memory 102 or the like, and based on the destination information M1 acquired by the destination information acquisition unit 1003, identifies a guidance parking frame Gp from among the parking frames Fp in the parking lot PA, which is a parking frame Fp whose evaluation value RV corresponding to the destination De of the user U satisfies a predetermined condition (for example, 50 or more). Here, the predetermined condition can be determined, for example, by the administrator of the parking lot management device 100.

More specifically, when the entry and exit detection unit 1002 detects that the vehicle V of the user U has entered the parking lot PA, the guidance parking frame identification unit 1004 identifies, as the guidance parking frame Gp, a parking frame Fp whose evaluation value RV satisfies the predetermined condition and in which no other vehicle other than the vehicle V of the user U is parked. The guidance parking frame information M2 indicating the guidance parking frame Gp identified by the guidance parking frame identification unit 1004 is transmitted to the user terminal TU via the communication unit 1001.

The used parking frame identification unit 1005 identifies a parking frame Fp in which the vehicle V of the user U is actually parked based on images from the camera CA installed in the parking lot PA.

The questionnaire generation unit 1006 generates a questionnaire for the user U to evaluate the guidance parking frame Gp to which the user U is guided based on the destination De. The questionnaire generation unit 1006 may generate a questionnaire, for example, when the vehicle V of the user U is parked in any parking frame Fp, including the guidance parking frame Gp, or may generate a questionnaire in advance before parking in the parking frame Fp. The questionnaire generation unit 1006 may generate a questionnaire in response to a request from the user U, or may generate a questionnaire in advance before a request from the user U. That is, the timing at which the questionnaire generation unit 1006 generates the questionnaire is not particularly limited.

The questionnaire generation unit 1006 may also generate a questionnaire based on a behavior of the vehicle V. In this case, the questionnaire generation unit 1006 may generate different questionnaires depending on the behavior of the vehicle V before parking in any of the parking frames Fp, including the guidance parking frame Gp. For example, if there is some problem with the guidance parking frame Gp, such as a size of the guidance parking frame Gp not fitting the vehicle V, the vehicle V may change an operation while parking in the guidance parking frame Gp (for example, stop parking in the guidance parking frame Gp and head to another parking frame Fp). In such a case, the questionnaire generation unit 1006 may generate a questionnaire asking about the problem of the guidance parking frame Gp as the parking frame Fp for parking the vehicle V.

For example, in a case where the guidance parking frame Gp is a parking frame Fp that is relatively close to an entrance of the facility FA, but the parking frame Fp (that is, the guidance parking frame Gp) is separated from the entrance of the facility FA by a fence or the like, and therefore parking in the parking frame Fp would require the user U to make a large detour to arrive at the entrance of the facility FA, the vehicle V may perform an operation such as heading to another parking frame Fp before parking in the parking frame Fp. In such a case, the questionnaire generation unit 1006 may generate a questionnaire that asks about the problem of the guidance parking frame Gp as a parking position.

For example, in a case where the vehicle V is directly parked in the guidance parking frame Gp, it is considered that there is no particular problem with the guidance parking frame Gp. In such a case, the questionnaire generation unit 1006 may generate a questionnaire to obtain feedback from the user U regarding usability of the guidance parking Frame Gp.

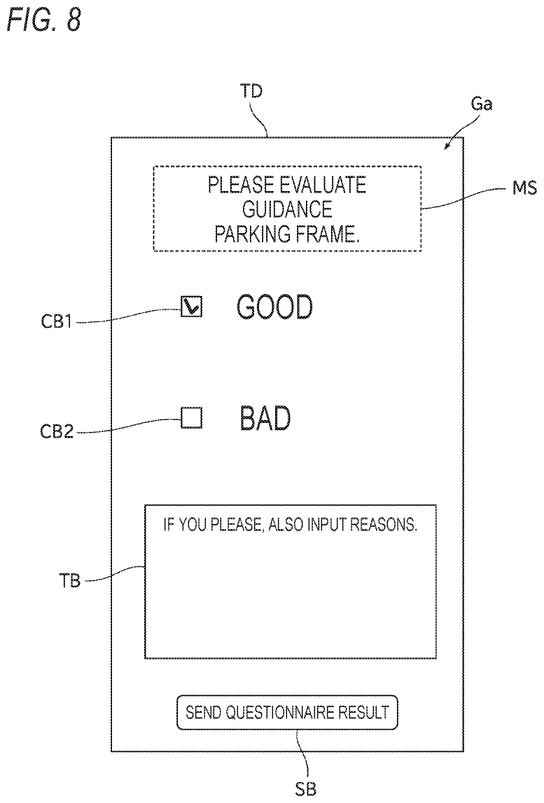

The questionnaire information M3 indicating the questionnaire generated by the questionnaire generation unit 1006 is transmitted to the user terminal TU via the communication unit 1001. Note that an example of the questionnaire generated by the questionnaire generation unit 1006 will be described below with reference to FIG. 8 and the like.

The parking frame information update unit 1007 updates the parking frame information 102a stored in the memory 102 based on the answer result information M4 received by the communication unit 1001. Here, the answer result information M4 is information that indicates an answer result of the user U to the questionnaire generated by the questionnaire generation unit 1006.

### User Terminal

As illustrated in FIG. 5, the user terminal TU includes a communication unit 2001, an input unit 2002, and a display unit 2003. The communication unit 2001 is implemented by, for example, the communication I/F 203. The input unit 2002 is implemented by, for example, the input device 204. The display unit 2003 is implemented by, for example, the display 205.

The communication unit 2001 communicates with the parking lot management device 100 via the communication network NET. For example, the communication unit 2001 receives the guidance parking frame information M2, the questionnaire information M3, and the like from the parking lot management device 100. The communication unit 2001 transmits the destination information M1, the answer result information M4, and the like to the parking lot management device 100.

The input unit 2002 receives various input operations by the user U. The various input operations include, for example, an operation to identify the destination De, as well as an operation to input the answer result to the questionnaire indicated by the questionnaire information M3 received by the user terminal TU. The destination information M1 indicating the destination De received by the input unit 2002 and the answer result information M4 indicating the answer result to the questionnaire are transmitted to the parking lot management device 100 via the communication unit 2001.

The display unit 2003 displays various screens. The screens displayed by the display unit 2003 include, for example, a screen that presents to the user U (that is, guides the user U to) the guidance parking frame Gp indicated by the guidance parking frame information M2, and a questionnaire screen Ga, which will be described below, based on the questionnaire information M3.

Note that by providing the user terminal TU with a touch panel display TD that can function as both the input device 204 and the display 205, the functions of the input unit 2002 and the display unit 2003 can be implemented by the touch panel display TD. In the following description, it is assumed that the user terminal TU is provided with the touch panel display TD, and that the questionnaire screen Ga and the like are displayed on this touch panel display TD.

### 6. Operation Example of Parking Lot Management Device and User Terminal

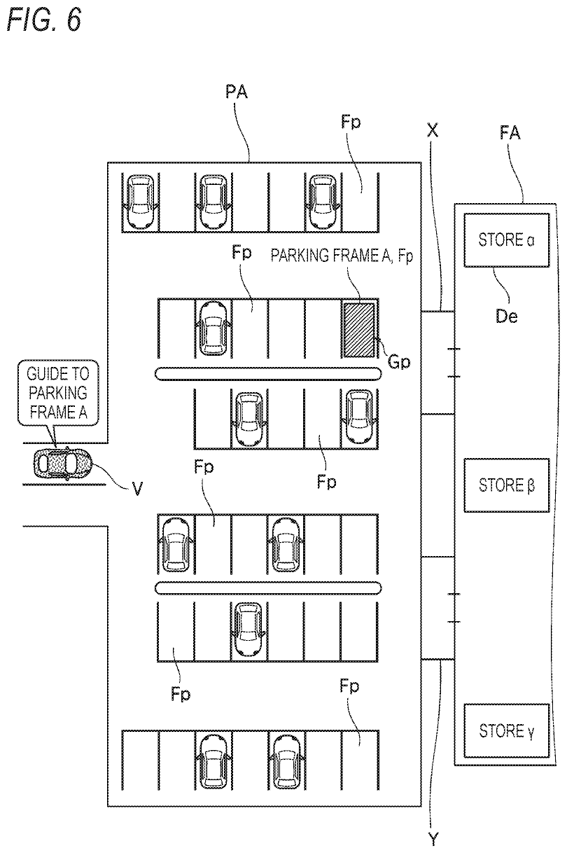

Next, an operation example of the parking lot management device 100 and the user terminal TU will be described with reference to FIGS. 6 to 9.

### Identification of Guidance Parking Frame

FIG. 6 illustrates a situation in the parking lot PA immediately after the vehicle V of the user U enters the parking lot PA. In the example illustrated in FIG. 6, the destination De of the vehicle V is set as the store α in the facility FA. The facility FA also has a first entrance X and a second entrance Y as entrances to the facility FA, each of which is adjacent to the parking lot PA. When the user U goes from the parking lot PA to the store α, which is the destination De, it is more convenient for the user U to enter the facility FA through the first entrance X, which is closer to the store α than the second entrance Y.

In such a case, the parking lot management device 100 refers to the parking frame information 102a illustrated in FIG. 3, and, based on the destination information M1 received from the user terminal TU of the user U of the vehicle V, identifies the parking frame A, which is a parking frame Fp whose evaluation value RV corresponding to the store α satisfies the predetermined condition and in which no other vehicle is parked, as the guidance parking frame Gp. Then, the parking lot management device 100 guides the user U to the parking frame A identified as the guidance parking frame Gp. As a result, among the currently available parking frames Fp in the parking lot PA, the user U can be guided to the parking frame A that is considered to be the most convenient for the user U who goes to the store α.

In this way, according to the present embodiment, among the plurality of parking frames Fp in the parking lot PA corresponding to the facility FA having the plurality of stores (the store α, the store β, and the store γ in the example illustrated in FIG. 6), the user U is guided to the parking frame Fp (here, the parking frame A) that has the highest evaluation value RV corresponding to the destination De of the user U and has no other vehicles parked therein. Therefore, the user U can be assisted in parking in the appropriate guidance parking frame Gp that takes into consideration the store (here, the store α) set as the destination De of the user U and the current situation of each parking frame Fp, thereby improving the convenience for the user U.

### Generation and Transmission of Questionnaire Information

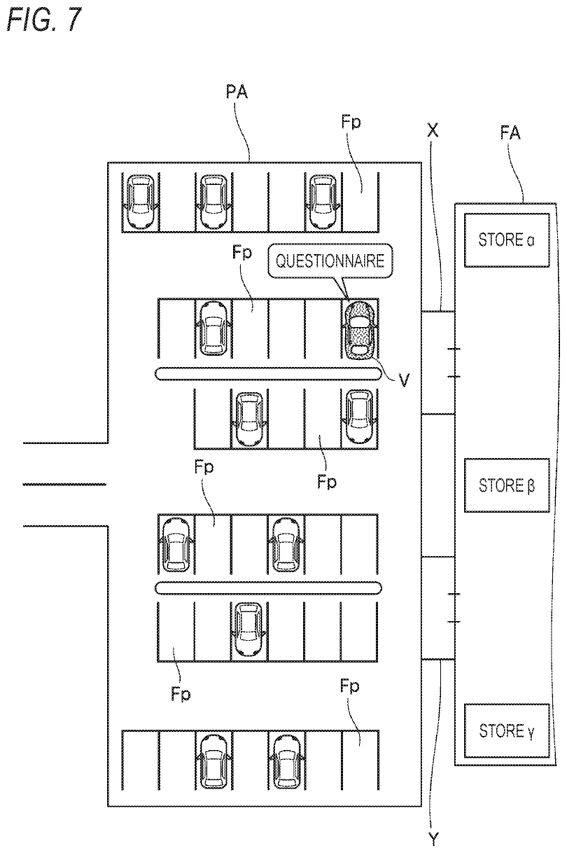

FIG. 7 illustrates a situation in which the vehicle V of the user U is parked in the parking frame A. After identifying the parking frame Fp in which the vehicle V of the user U is actually parked, the parking lot management device 100 generates a questionnaire for the user U to evaluate the guidance parking frame Gp. Then, the parking lot management device 100 transmits the questionnaire information M3 indicating the generated questionnaire to the user terminal TU. In this way, the user U is urged to evaluate the guidance parking frame Gp to which the user U is guided based on the destination De of the user U, and it is possible to update the parking frame information 102a based on the evaluation.

For example, the parking lot management device 100 transmits the questionnaire information M3 to the user terminal TU before the user U gets off the vehicle V in the parking lot PA, when the user U who has gotten off the vehicle V in the parking lot PA gets back on the vehicle V, or after the user U arrives at the destination De (for example, the store α). In this way, it is possible to transmit the questionnaire information M3 to the user terminal TU at a timing when it is estimated that the user U has determined the evaluation on the guidance parking frame Gp to which the user U is guided. Therefore, it is possible to obtain the answer result to the questionnaire from the user U who has determined the evaluation on the guidance parking frame Gp.

However, if the vehicle V of the user U is parked in a parking frame Fp different from the guidance parking frame Gp, there is a possibility that the guidance parking frame Gp is not an appropriate parking frame Fp for the destination De of the user U. Therefore, the parking lot management device 100 may generate a questionnaire (that is, the questionnaire information M3) when the vehicle V of the user U is parked in a parking frame Fp that is different from the guidance parking frame Gp. In this way, if there is a possibility that the guidance parking frame Gp is not an appropriate parking frame Fp for the user U, it is possible to update the parking frame information 102a based on the evaluation of the user U.

On the other hand, if the vehicle V of the user U is parked in the guidance parking frame Gp, there is a high possibility that the guidance parking frame Gp is an appropriate parking frame Fp for the destination De of the user U. Therefore, the parking lot management device 100 may generate a questionnaire in response to a request from the user U when the vehicle V of the user U is parked in the guidance parking frame Gp. As an example, in this case, the parking lot management device 100 may generate a questionnaire only when a request for generating a questionnaire based on an operation by the user U is received from the user terminal TU. In this way, the questionnaire information M3 can be prevented from being transmitted to the user terminal TU of the user U who does not wish to answer the questionnaire, thereby reducing inconvenience for the user U who does not wish to answer the questionnaire.

### Questionnaire Screen

FIG. 8 illustrates an example of the questionnaire screen Ga displayed on the touch panel display TD of the user terminal TU. For example, when the user terminal TU receives the questionnaire information M3 from the parking lot management device 100, the user terminal TU displays the questionnaire screen Ga illustrated in FIG. 8 on the touch panel display TD based on the received questionnaire information M3.

The questionnaire screen Ga illustrated in FIG. 8 includes a first check box CB1 for selecting “GOOD” as the evaluation on the guidance parking frame Gp to which the user U is guided by the parking lot management device 100, a second check box CB2 for selecting “BAD” as the evaluation, a text box TB for inputting a reason for the evaluation, a message MS urging the user U to answer the questionnaire, and a send button SB for receiving an operation to send the answer result to the questionnaire.

In such a case, the user U can input the answer result to the questionnaire to the user terminal TU by checking the first check box CB1 or the second check box CB2 on the questionnaire screen Ga and entering the reason for evaluation in the text box TB as appropriate. Then, the user U can operate (for example, tap) the send button SB to send the answer result information M4 indicating the answer result to the questionnaire from the user terminal TU to the parking lot management device 100.

### Update of Parking Frame Information

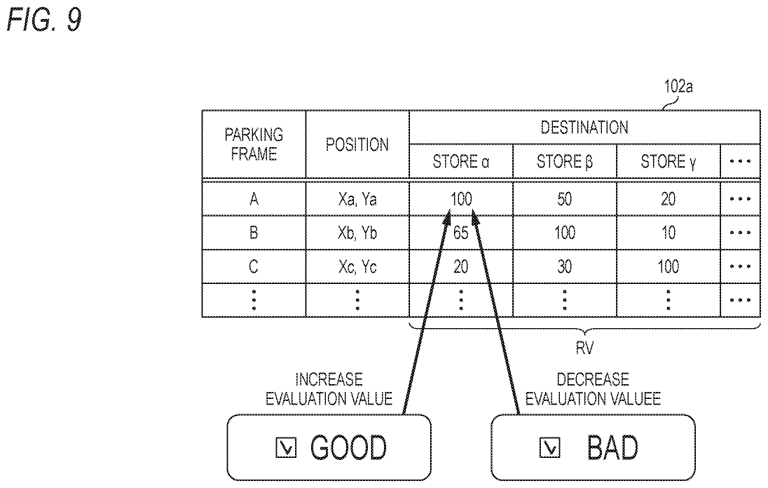

FIG. 9 illustrates an example of update of the parking frame information 102a. The parking lot management device 100 updates the parking frame information 102a based on the answer result information M4 received from the user terminal TU. Note that in this case, as in the example illustrated in FIG. 6, the destination De of the vehicle V is set as the store α, and it is assumed that the user U is guided to the parking frame A as the guidance parking frame Gp.

In such a case, the parking lot management device 100 updates the evaluation value RV corresponding to the parking frame A, which is the guidance parking frame Gp, based on the answer result information M4 received from the user terminal TU. For example, if the evaluation on the parking frame A set as the guidance parking frame Gp is “GOOD”, the parking lot management device 100 increases the evaluation value RV corresponding to the store α of the parking frame A by a predetermined amount (for example, +1). On the other hand, if the evaluation on the parking frame A set as the guidance parking frame Gp is “BAD”, the parking lot management device 100 decreases the evaluation value RV corresponding to the store α of the parking frame A by a predetermined amount (for example, −1). The amount by which the evaluation value RV is changed for each evaluation can be determined appropriately by the administrator of the parking lot management device 100 or the like. The amount by which the evaluation value RV is changed for each evaluation may differ depending on the reason for evaluation.

As described above, according to the present embodiment, the parking frame information 102a can be automatically updated based on the evaluation by the user U on the guidance parking frame Gp to which the user U is guided. In this way, trouble required for the administrator of the parking lot management device 100 to update the parking frame information 102a is reduced. By updating only the evaluation value RV corresponding to the guidance parking frame Gp to which the user U is guided, it is possible to minimize the number of update targets and reduce the processing burden when automatically updating the parking frame information 102a.

### 7. Processing Performed by Parking Lot Management Device

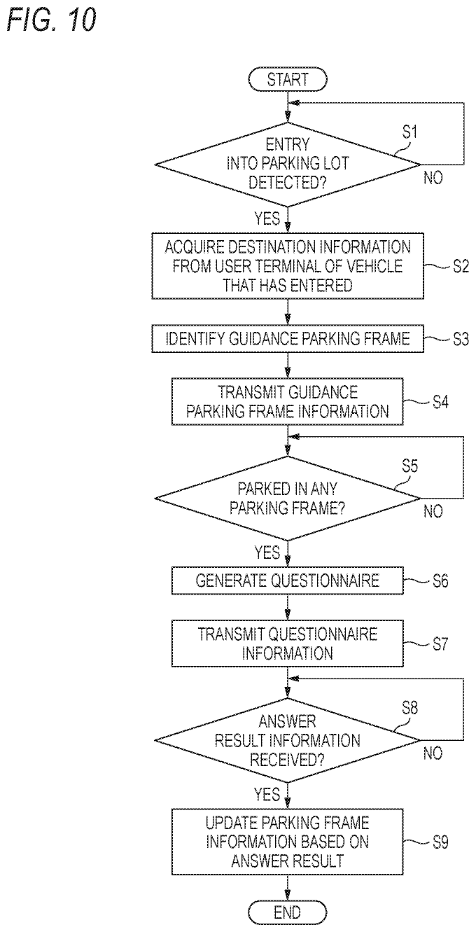

Next, an example of processing performed by the parking lot management device 100 will be described according to a flowchart illustrated in FIG. 10.

As illustrated in FIG. 10, the parking lot management device 100 first determines whether entry of the vehicle V into the parking lot PA has been detected (step S1). If it is determined that the entry of the vehicle V into the parking lot PA has not been detected (step S1: NO), the parking lot management device 100 repeats the processing of step S1 until the entry of the vehicle V into the parking lot PA is detected. Then, if it is determined that the entry of the vehicle V into the parking lot PA has been detected (step S1: YES), the parking lot management device 100 acquires the destination information M1 from the user terminal TU of the vehicle V that has entered the parking lot PA (step S2).

Next, based on the acquired destination information M1, the parking lot management device 100 identifies a guidance parking frame Gp, which is a parking frame Fp whose evaluation value RV corresponding to the destination De of the user U satisfies a predetermined condition (step S3). Then, the parking lot management device 100 transmits the guidance parking frame information M2 indicating the identified guidance parking frame Gp to the user terminal TU (step S4).

Next, the parking lot management device 100 determines whether the vehicle V has been parked in any of the parking frames Fp in the parking lot PA (step S5). If it is determined that the vehicle V is not parked (step S5: NO), the parking lot management device 100 repeats the processing of step S5 until the vehicle V is parked.

Then, if it is determined that the vehicle V has been parked in one of the parking frames Fp (step S5: YES), the parking lot management device 100 generates a questionnaire for the user U to evaluate the guidance parking frame Gp (step S6). Then, the parking lot management device 100 transmits the questionnaire information M3 indicating the generated questionnaire to the user terminal TU (step S7).

Next, the parking lot management device 100 determines whether the answer result information M4 has been received from the user terminal TU (step S8). If it is determined that the answer result information M4 is not received (step S8: NO), the parking lot management device 100 repeats the processing of step S8 until the answer result information M4 is received.

Then, if it is determined that the answer result information M4 has been received (step S8: YES), the parking lot management device 100 updates the parking frame information 102a based on the answer result indicated by the received answer result information M4 (step S9), and ends the series of processing.

As described above, the parking lot management device 100 of the present embodiment identifies the guidance parking frame Gp whose evaluation value RV corresponding to the destination De of the user U satisfies a predetermined condition based on the destination information M1 acquired from the user terminal TU of the vehicle V that has entered the parking lot PA, and transmits the guidance parking frame information M2 indicating the guidance parking frame Gp to the user terminal TU of the vehicle V. In this way, the user U can be guided to the guidance parking frame Gp whose evaluation value RV corresponding to the destination De of the user U satisfies the predetermined condition.

When the vehicle V is parked in one of the parking frames Fp in the parking lot PA, the parking lot management device 100 can urge the user U to evaluate the guidance parking frame Gp by transmitting, to the user terminal TU, the questionnaire information M3 indicating the questionnaire about the guidance parking frame Gp to which the user U is guided based on the destination De.

The parking lot management device 100 then receives the answer result information M4 indicating the answer result to the questionnaire from the user terminal TU, and updates the parking frame information 102a based on the answer result, thereby automatically updating the parking frame information 102a based on the evaluation by the user U.

### 8. Modifications

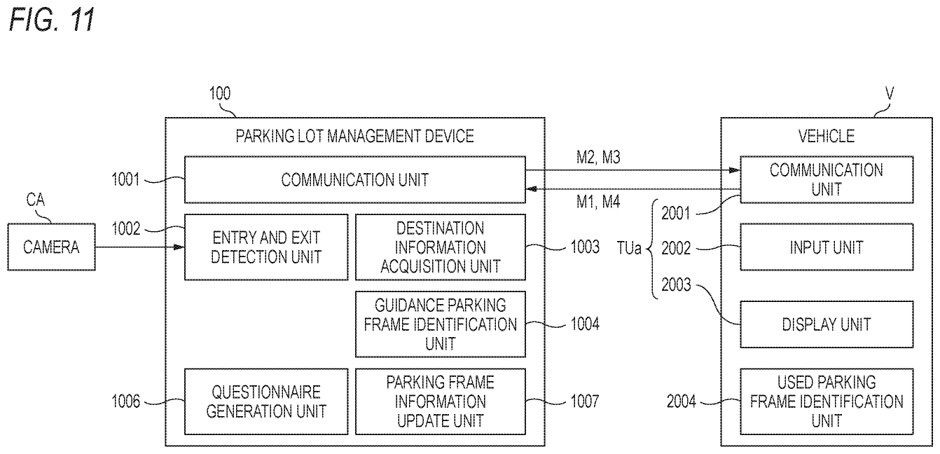

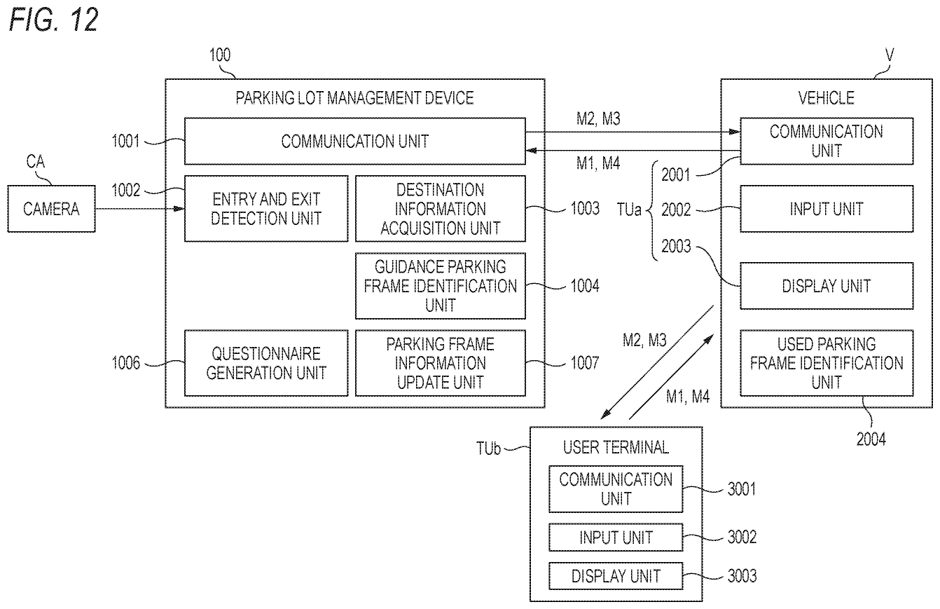

Next, modifications of the above-described embodiment will be described with reference to FIGS. 11 and 12. Note that in the following description, constituent elements common to the above-described embodiment will be denoted by the same reference numerals, and description thereof will be omitted or simplified as appropriate.

### First Modification

As illustrated in FIG. 11, the vehicle V of the first modification includes a navigation device TUa as the user terminal TU. The vehicle V of the first modification includes a used parking frame identification unit 2004. The used parking frame identification unit 2004 is, for example, a camera provided in the vehicle V or a global navigation satellite system (GNSS) receiver or the like, and identifies the parking frame Fp in which the vehicle V is actually parked. The used parking frame identification unit 2004 is implemented by, for example, a processor (for example, an electronic control unit (ECU)) (not illustrated) provided in the vehicle V executing a pre-stored program.

In this case, the parking lot management device 100 may not include the used parking frame identification unit 1005. That is, the used parking frame identification unit 2004 identifies the parking frame Fp in which the vehicle V is actually parked, and information indicating the identified parking frame Fp may be transmitted to the parking lot management device 100 via the communication unit 2001.

Then, the parking lot management device 100 receives from the vehicle V the information indicating the parking frame Fp in which the vehicle V is actually parked, and transmits the questionnaire information M3 to the vehicle V (for example, the navigation device TUa) when, for example, the vehicle V is parked in a parking frame Fp different from the guidance parking frame Gp. In this way, in the first modification, as in the above-mentioned embodiment, it is possible to urge the user U to evaluate the guidance parking frame Gp and to update the parking frame information 102a based on the evaluation by the user U.

### Second Modification

The second modification illustrated in FIG. 12 differs from the first modification illustrated in FIG. 11 in that a smartphone TUb of the user U communicates with the parking lot management device 100 via the vehicle V. In this case, the smartphone TUb includes, for example, a communication unit 3001 capable of communicating with the communication unit 2001 of the vehicle V, an input unit 3002 having functions similar to those of the input unit 2002 of the vehicle V, and a display unit 3003 having functions similar to those of the display unit 2003 of the vehicle V. Note that in the second modification, the input unit 2002 and the display unit 2003 of the vehicle V may be omitted.

In this case, the smartphone TUb transmits the destination information M1 and the answer result information M4 to the vehicle V, for example, based on an operation of the user U received by the input unit 3002. Then, the vehicle V transmits the destination information M1 and the answer result information M4 received from the smartphone TUb to the parking lot management device 100. In this case, the vehicle V receives the guidance parking frame information M2 and the questionnaire information M3 from the parking lot management device 100, and transmits the received information to the smartphone TUb. Even in this case, the same effects as those of the above-described embodiment or the first modification can be obtained.

In the case of the second modification, the questionnaire information M3 is particularly transmitted to the smartphone TUb, so that the user U can be urged to evaluate the guidance parking frame Gp regardless of where the user U is. For example, the smartphone TUb may transmit position information indicating a position thereof to the parking lot management device 100 via the vehicle V, and the parking lot management device 100 may transmit the questionnaire information M3 to the smartphone TUb via the vehicle V at a timing when it is estimated that the user U has arrived at the destination De (for example, the store α). In this way, after the user U arrives at the destination De, the questionnaire information M3 can be transmitted to the smartphone TUb. Then, the user U can answer the questionnaire by using the smartphone TUb.

In this way, according to the second modification, it is possible to obtain the answer result to the questionnaire from the user U who has determined the evaluation on the guidance parking frame Gp, regardless of where the user U is.

As described above, according to the present embodiment and the modifications thereof, convenience for the user U who wishes to use the parking lot PA having the plurality of parking frames Fp available for parking the vehicle V can be improved. This hence can contribute to development of a sustainable transportation system.

Although various embodiments have been described above with reference to the drawings, it is needless to say that the present disclosure is not limited to these examples. It is apparent to those skilled in the art that various changes or modifications can be conceived within the scope described in the claims, and it is understood that the changes or modifications naturally fall within the technical scope of the present disclosure. In addition, the constituent elements in the above embodiment may be freely combined without departing from the gist of the disclosure.

Furthermore, the parking lot management method (in other words, the parking assistance method) described in the above embodiment can be implemented by a computer executing a program prepared in advance. For example, the program is stored in a computer-readable storage medium and executed by being read from the storage medium. The program may be provided in a form of being stored in a non-transitory storage medium such as a flash memory, or may be provided via a network such as the Internet.

In the present specification, at least the following matters are described. In the parentheses, the corresponding constituent elements and the like in the above embodiment are shown as examples, but the present disclosure is not limited thereto.
(1) A parking lot management device (parking lot management device 100) that guides a user (user U), who wishes to use a parking lot (parking lot PA) having a plurality of parking frames (parking frames Fp) available for parking a vehicle (vehicle V), to a parking frame identified from among the plurality of parking frames, the parking lot management device including:
an acquisition unit (destination information acquisition unit 1003) configured to acquire destination information (destination information M1) indicating a destination (destination De) of the user;
a guidance parking frame identification unit (guidance parking frame identification unit 1004) configured to refer to a storage unit (memory 102) that stores parking frame information (parking frame information 102a) indicating an evaluation value of each parking frame for each destination, and identify a guidance parking frame (guidance parking frame Gp), which is a parking frame whose evaluation value (evaluation value RV) corresponding to the destination of the user satisfies a predetermined condition, from among the plurality of parking frames based on the destination information acquired by the acquisition unit; and
a communication unit (communication unit 1001) configured to transmit guidance parking frame information (guidance parking frame information M2) indicating the guidance parking frame identified by the guidance parking frame identification unit to a user terminal (user terminal TU) used by the user.

According to (1), it is possible to guide the user to a guidance parking frame that is a parking frame whose evaluation value corresponding to the destination of the user satisfies a predetermined condition. In this way, the user can be assisted in parking in an appropriate guidance parking frame that takes into consideration the destination of the user, thereby improving the convenience for the user.
(2) The parking lot management device according to (1), further including:
a questionnaire generation unit (questionnaire generation unit 1006) configured to generate a questionnaire for the user to evaluate the guidance parking frame to which the user is guided based on the destination, in which
the communication unit transmits, to the user terminal, questionnaire information (questionnaire information M3) indicating the questionnaire generated by the questionnaire generation unit.

According to (2), the user can be urged to evaluate the guidance parking frame to which the user is guided based on the destination, and the parking frame information can be updated based on the evaluation.
(3) The parking lot management device according to (2), in which
the questionnaire generation unit generates the questionnaire when the vehicle of the user is parked in a parking frame different from the guidance parking frame.

When the vehicle of the user is parked in a parking frame different from the guidance parking frame, there is a possibility that the guidance parking frame is not an appropriate parking frame for the destination of the user. According to (3), by urging the user to evaluate the guidance parking frame in this case, the parking frame information can be updated based on the evaluation.
(4) The parking lot management device according to (2), in which
the questionnaire generation unit generates the questionnaire in response to a request from the user.

According to (4), by generating a questionnaire in response to a request from the user, it is possible to reduce inconvenience for the user who does not wish to answer the questionnaire.
(5) The parking lot management device according to any one of (2) to (4), further including:
a parking frame information update unit (parking frame information update unit 1007) configured to update the parking frame information stored in the storage unit, in which
the communication unit receives, from the user terminal, answer result information (answer result information M4) indicating an answer result of the user to the questionnaire, and
the parking frame information update unit updates the parking frame information based on the answer result information received by the communication unit.

According to (5), the parking frame information can be automatically updated based on the evaluation by the user on the guidance parking frame to which the user is guided, thereby reducing the trouble required for the administrator of the parking lot management device to update the parking frame information.
(6) The parking lot management device according to (5), in which
the parking frame information update unit updates the evaluation value corresponding to the guidance parking frame in the parking frame information based on the answer result information received by the communication unit.

According to (6), it is possible to minimize the number of update targets and reduce the processing burden when automatically updating the parking frame information, and to appropriately update the parking frame information based on the evaluation by the user on the guidance parking frame to which the user is guided.
(7) The parking lot management device according to any one of (2) to (4), in which
the communication unit transmits the questionnaire information to the user terminal before the user gets off the vehicle in the parking lot, when the user who has gotten off the vehicle gets back on the vehicle in the parking lot, or after the user arrives at the destination.

According to (7), it is possible to transmit the questionnaire information to the user terminal at a timing when it is estimated that the user has determined the evaluation on the guidance parking frame to which the user is guided. Therefore, it is possible to obtain the answer result to the questionnaire from the user who has determined the evaluation on the guidance parking frame.
(8) The parking lot management device according to any one of (2) to (4), further including:
an entry detection unit (entry and exit detection unit 1002) that detects entry of the vehicle of the user into the parking lot, in which
when the entry detection unit detects that the vehicle of the user has entered the parking lot, the guidance parking frame identification unit identifies, as the guidance parking frame, a parking frame whose evaluation value satisfies the predetermined condition and in which no other vehicles other than the vehicle of the user is parked.

According to (8), the user can be assisted in parking in an appropriate guidance parking frame that takes into consideration the current availability of each parking frame and the destination of the user, thereby improving convenience for the user.
(9) The parking lot management device according to any one of (2) to (4), in which
the user terminal is a device installed in the vehicle (navigation device TUa) or a portable terminal of the user that is capable of communicating with the vehicle (smartphone TUb).

According to (9), it is possible to present to the user the guidance parking frame and the questionnaire via a device installed in the vehicle used by the user or a portable terminal, thereby improving the convenience for the user.
(10) The parking lot management device according to any one of (2) to (4), in which
the parking lot is a parking lot provided corresponding to a facility having a plurality of stores (store α, store β, store γ),
the parking frame information indicates the evaluation value of each parking frame for each store, and
the guidance parking frame identification unit identifies, from among the plurality of parking frames, the guidance parking frame whose evaluation value corresponding to a store that is set as the destination among the plurality of stores satisfies the predetermined condition.

According to (10), the user can be assisted in parking in an appropriate guidance parking frame that takes into consideration the store set as the destination of the user from among the plurality of parking frames in the parking lot corresponding to the facility having the plurality of stores, thereby improving the convenience for the user.
(11) A parking lot management method, in which
a computer that guides a user, who wishes to use a parking lot having a plurality of parking frames available for parking a vehicle, to a parking frame identified from among the plurality of parking frames executes processing of
acquiring destination information indicating a destination of the user,
referring to a storage unit that stores parking frame information indicating an evaluation value of each parking frame for each destination, and identifying a guidance parking frame, which is a parking frame whose evaluation value corresponding to the destination of the user satisfies a predetermined condition, from among the plurality of parking frames based on the acquired destination information, and
transmitting guidance parking frame information indicating the identified guidance parking frame to a user terminal used by the user.

According to (11), it is possible to guide the user to a guidance parking frame that is a parking frame whose evaluation value corresponding to the destination of the user satisfies a predetermined condition. In this way, the user can be assisted in parking in an appropriate guidance parking frame that takes into consideration the destination of the user, thereby improving the convenience for the user.
(12) A program that causes a computer that guides a user, who wishes to use a parking lot having a plurality of parking frames available for parking a vehicle, to a parking frame identified from among the plurality of parking frames to execute processing of
acquiring destination information indicating a destination of the user,
referring to a storage unit that stores parking frame information indicating an evaluation value of each parking frame for each destination, and identifying a guidance parking frame, which is a parking frame whose evaluation value corresponding to the destination of the user satisfies a predetermined condition, from among the plurality of parking frames based on the acquired destination information, and
transmitting guidance parking frame information indicating the identified guidance parking frame to a user terminal used by the user.

According to (12), it is possible to guide the user to a guidance parking frame that is a parking frame whose evaluation value corresponding to the destination of the user satisfies a predetermined condition. In this way, the user can be assisted in parking in an appropriate guidance parking frame that takes into consideration the destination of the user, thereby improving the convenience for the user.

1. A parking lot management device, wherein
the parking lot management device guides a user, who wishes to use a parking lot having a plurality of parking frames available for parking a vehicle, to a parking frame identified from among the plurality of parking frames, and
the parking lot management device comprises a processor configured to:
acquire destination information indicating a destination of the user;
refer to a storage that stores parking frame information indicating an evaluation value of each parking frame for each destination, and identify a guidance parking frame, which is a parking frame whose evaluation value corresponding to the destination of the user satisfies a predetermined condition, from among the plurality of parking frames based on the acquired destination information; and
transmit guidance parking frame information indicating the identified guidance parking frame to a user terminal used by the user.

2. The parking lot management device according to claim 1, wherein the processor is further configured to:
generate a questionnaire for the user to evaluate the guidance parking frame to which the user is guided based on the destination; and
transmit, to the user terminal, questionnaire information indicating the generated questionnaire.

3. The parking lot management device according to claim 2, wherein the processor is configured to generate the questionnaire when the vehicle of the user is parked in a parking frame different from the guidance parking frame.

4. The parking lot management device according to claim 2, wherein the processor is configured to generate the questionnaire in response to a request from the user.

5. The parking lot management device according to claim 2, wherein the processor is configured to:
update the parking frame information stored in the storage;
receive, from the user terminal, answer result information indicating an answer result of the user to the questionnaire; and
update the parking frame information based on the received answer result information.

6. The parking lot management device according to claim 5, wherein the processor is configured to update the evaluation value corresponding to the guidance parking frame in the parking frame information based on the received answer result information.

7. The parking lot management device according to claim 2, wherein the processor transmits the questionnaire information to the user terminal before the user gets off the vehicle in the parking lot, when the user who has gotten off the vehicle gets back on the vehicle in the parking lot, or after the user arrives at the destination.

8. The parking lot management device according to claim 2, wherein
the processor is configured to detect entry of the vehicle of the user into the parking lot, and
when detecting that the vehicle of the user has entered the parking lot, the processor identifies, as the guidance parking frame, a parking frame whose evaluation value satisfies the predetermined condition and in which no other vehicles other than the vehicle of the user is parked.

9. The parking lot management device according to claim 2, wherein
the user terminal is a device installed in the vehicle or a portable terminal of the user that is capable of communicating with the vehicle.

10. The parking lot management device according to claim 2, wherein
the parking lot is a parking lot provided corresponding to a facility having a plurality of stores,
the parking frame information indicates the evaluation value of each parking frame for each store, and
the processor identifies, from among the plurality of parking frames, the guidance parking frame whose evaluation value corresponding to a store that is set as the destination among the plurality of stores satisfies the predetermined condition.

11. A parking lot management method performed by a computer, wherein
the computer guides a user, who wishes to use a parking lot having a plurality of parking frames available for parking a vehicle, to a parking frame identified from among the plurality of parking frames, and
the parking lot management method comprises:
acquiring destination information indicating a destination of the user;
referring to a storage that stores parking frame information indicating an evaluation value of each parking frame for each destination, and identifying a guidance parking frame, which is a parking frame whose evaluation value corresponding to the destination of the user satisfies a predetermined condition, from among the plurality of parking frames based on the acquired destination information; and
transmitting guidance parking frame information indicating the identified guidance parking frame to a user terminal used by the user.

12. A non-transitory computer-readable storage medium storing a program for causing a computer to execute a process, wherein
the computer guides a user, who wishes to use a parking lot having a plurality of parking frames available for parking a vehicle, to a parking frame identified from among the plurality of parking frames, and
the process comprises:
acquiring destination information indicating a destination of the user;
referring to a storage that stores parking frame information indicating an evaluation value of each parking frame for each destination, and identifying a guidance parking frame, which is a parking frame whose evaluation value corresponding to the destination of the user satisfies a predetermined condition, from among the plurality of parking frames based on the acquired destination information; and
transmitting guidance parking frame information indicating the identified guidance parking frame to a user terminal used by the user.
